(19) United States
(12) Patent Application Publication
(10) Pub. No.: US 2017/0238520 A1
(43) Pub. Date: Aug. 24, 2017

(54) NIGHTTIME FISHING ASSEMBLY

(71) Applicant: Steve Milligan, Haleyville, AL (US)

(72) Inventor: Steve Milligan, Haleyville, AL (US)

(21) Appl. No.: 15/048,592

(22) Filed: Feb. 19, 2016

(51) Int. Cl. A01K 97/10; H02J 7/00; F21S 6/00; F21S 9/02; F21V 23/04

(52) U.S. Cl. CPC A01K 97/10; F21S 9/02; F21V 23/04; F21S 6/005; H02J 7/0042; F21Y 2115/10

(57) ABSTRACT

A nighttime fishing assembly includes a stand that may be positioned on a support surface thereby facilitating the stand to support at least one fishing pole. The stand may be positioned adjacent to a body of water thereby facilitating a line of the fishing pole to be cast into the body of water. A lighting unit is removably coupled to the stand when the stand is positioned in the support surface. The lighting unit emits ultraviolet light thereby facilitating the line from the at least one fishing pole to fluoresce at night.

### BACKGROUND OF THE DISCLOSURE

Field of the Disclosure

The disclosure relates to fishing devices and more particularly pertains to a new fishing device for supporting at least one fishing pole and illuminating a line on the at least one fishing pole.

### SUMMARY OF THE DISCLOSURE

An embodiment of the disclosure meets the needs presented above by generally comprising a stand that may be positioned on a support surface thereby facilitating the stand to support at least one fishing pole. The stand may be positioned adjacent to a body of water thereby facilitating a line of the fishing pole to be cast into the body of water. A lighting unit is removably coupled to the stand when the stand is positioned in the support surface. The lighting unit emits ultraviolet light thereby facilitating the line from the at least one fishing pole to fluoresce at night.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a nighttime fishing assembly according to an embodiment of the disclosure.

FIG. 2 is a back view of an embodiment of the disclosure.

FIG. 3 is a side perspective in-use view of an embodiment of the disclosure.

### DESCRIPTION OF THE PREFERRED EMBODIMENT

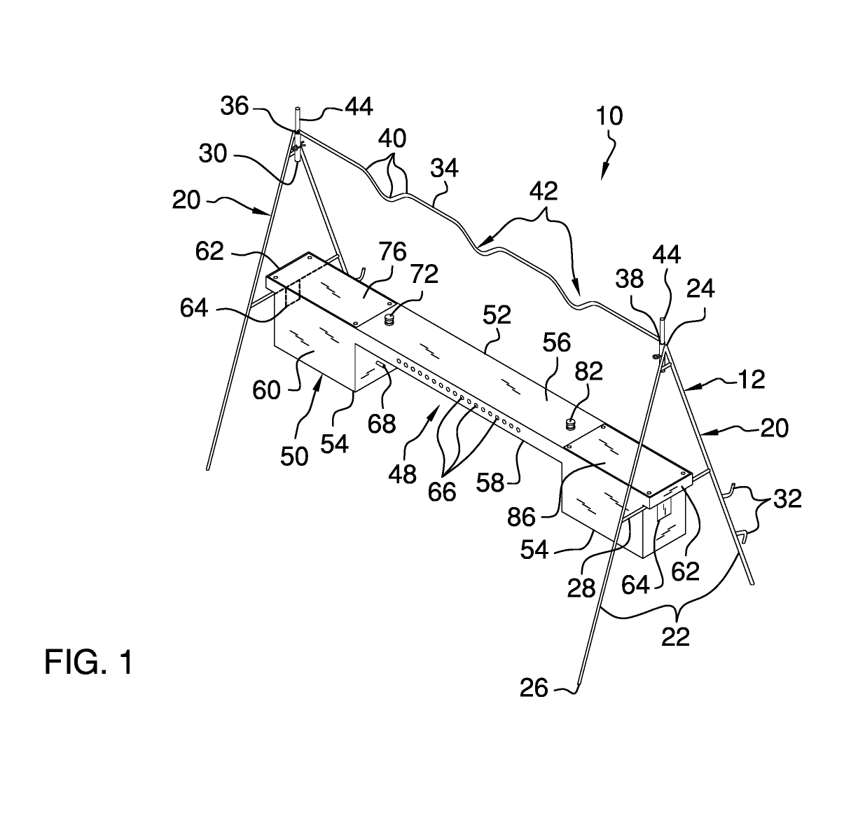

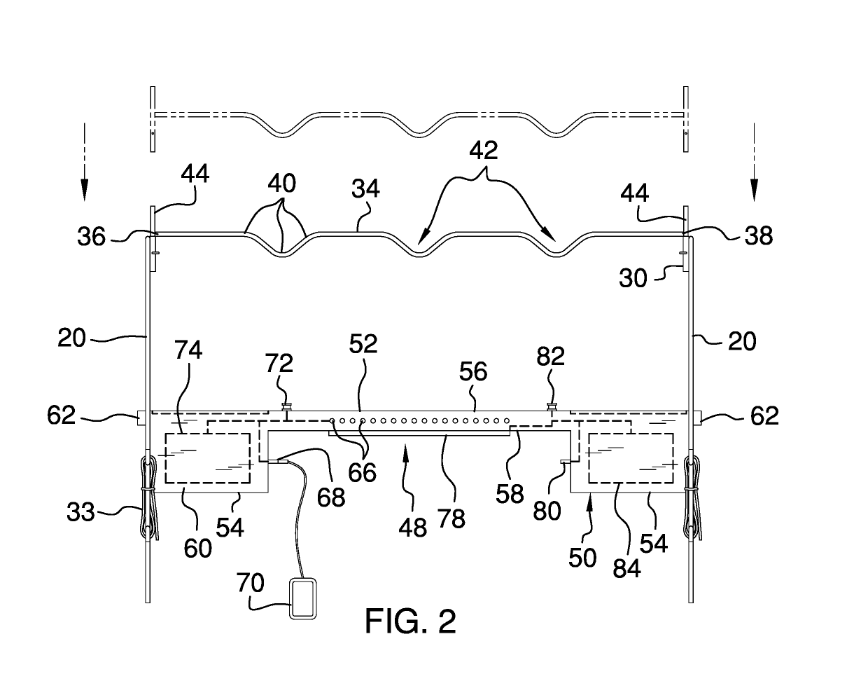

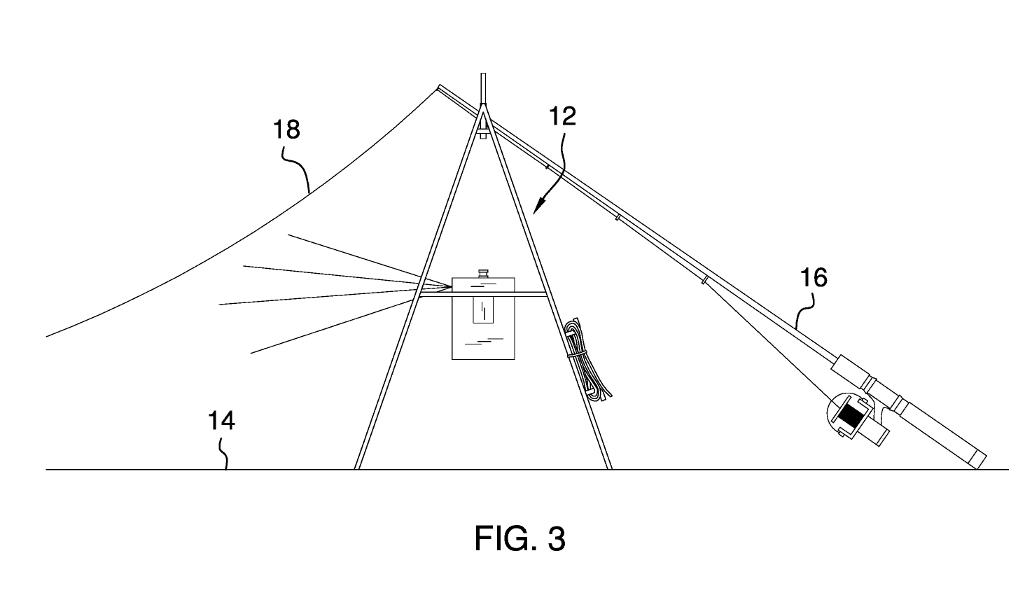

With reference now to the drawings, and in particular to FIGS. 1 through 3 thereof, a new fishing device embodying the principles and concepts of an embodiment of the disclosure and generally designated by the reference numeral 10 will be described.

As best illustrated in FIGS. 1 through 3, the nighttime fishing assembly 10 generally comprises a stand 12 that may be positioned on a support surface 14 thereby facilitating the stand 12 to support at least one fishing pole 16. The support surface 14 may comprise ground or the like. The stand 12 may to be positioned adjacent to a body of water. Thus, a line 18 of the fishing pole 16 may be cast into the body of water.

The stand 12 comprises a pair of uprights 20. Each of the uprights 20 may extend upwardly from the support surface 14. The uprights 20 may be spaced apart from each other. Each of the uprights 20 comprises a pair of outward arms 22. Each of the outward arms 22 has a first end 24 and a second end 26. The first end 24 corresponding to each of the outward arms 22 is coupled together such that the second end 26 corresponding to each of the outward arms 22 is spaced apart from each other. The second end 26 corresponding to each of the outward arms 22 abuts the support surface 14.

A central arm 28 is coupled to and extends between the pair of outward arms 22. The central arm 28 is centrally positioned between the first end 24 and the second end 26. A sleeve 30 is coupled to the outward arms 22 and the sleeve 30 is positioned on an intersection of the first end 24 corresponding to the outward arms 22. The sleeve 30 is oriented such that a line extending longitudinally through the sleeve 30 bisects a triangle formed by the outward arms 22.

A pair of hooks 32 is provided. Each of the hooks 32 is coupled to and extends away from one of the outward arms 22. Each of the hooks 32 may have a rope 33 attached thereto. The rope 33 may be attached to the support surface 14 thereby facilitating the outward arms 22 to be restrained on the support surface 14.

A middle member 34 is suspended between the pair of uprights 20 when the uprights 20 are positioned on the support surface 14. The middle member 34 may have the at least one fishing pole 16 leaned thereon. The middle member 34 has a primary end 36 and a secondary end 38. The middle member 34 has a plurality of bends 40 thereon.

The bends 40 are spaced apart from each other and are distributed along the middle member 34.

The bends 40 define a plurality of valleys 42 on the middle member 34. A selected one of the valleys 42 may have the at least one fishing pole 16 positioned therein. Thus, the at least one fishing pole 16 is inhibited from sliding laterally along the middle member 34. Each of the valleys 42 may have a fishing pole positioned therein.

The middle member 34 includes a pair of rods 44. Each of the rods 44 is coupled to an associated one of the primary end 36 and the secondary end 38. Each of the rods 44 is oriented transverse to the middle member 34. The sleeve 30 corresponding to each of the uprights 20 slidably receives an associated one of the rods 44. Thus, the middle member 34 extends between the pair of uprights 20 and the valleys 42 point toward the support surface 14.

A lighting unit 48 is removably coupled to the stand 12 when the stand 12 is positioned in the support surface 14. The lighting unit 48 emits ultraviolet light thereby facilitating the line 18 from the at least one fishing pole 16 to fluoresce at night. The lighting unit 48 comprises a housing 50 that includes a central box 52 extending between a pair of end boxes 54. The end boxes 54 are spaced apart from each other. Each of the end boxes 54 extends downwardly from the central box 52.

The housing 50 has a bottom side 56, a top side 58 and a front side 60. The central box 52 extends beyond each of the end boxes 54 to define a pair of ledges 62 on the housing 50. Each of the ledges 62 rests on the central arm 28 of an associated one of the uprights 20. Thus, the housing 50 is supported above the support surface 14. The front side 60 of the housing 50 faces the line 18 when the line 18 is cast into the body of water.

A pair of plates 64 is coupled to the central box 52. Each of the plates 64 extends downwardly from an associated one of the ledges 62. The central arm 28 of each of the uprights 20 is positioned between the associated plates 64 and the corresponding end box 54. Thus, the plates 64 inhibit the housing 50 from sliding off of the stand 12.

A plurality of first light emitters 66 is included. Each of the first light emitters 66 is coupled to the housing 50. Each of the first light emitters 66 is positioned on the front side 60 corresponding to the central box 52. Each of the first light emitters 66 emits light outwardly from the housing 50. Thus, the first light emitters 66 illuminate the line 18 on the at least one fishing pole 16. Each of the first light emitters 66 may comprise a UV LED or the like thereby facilitating the line 18 to fluoresce.

A first charge port 68 is coupled to the housing 50. The first charge port 68 is positioned an associated one of the end boxes 54. The first charge port 68 may be electrically coupled to an extrinsic electronic device 70. The extrinsic electronic device 70 may comprise a smart phone or the like. Thus, the first charge port 68 facilitates the extrinsic electronic device 70 to be remotely charged.

A first switch 72 is coupled to the housing 60 and the first switch 72 may be manipulated. The first switch 72 is electrically coupled to each of the first light emitters 66. The first switch 72 is positioned on the top side 58 corresponding to the central box 52. A first power supply 74 is positioned in an associated one of the end boxes 54 and the first power supply 74 is electrically coupled to the first switch 72. The first power supply 74 comprises at least one battery. A first battery cover 76 is removably coupled to the top side 58 of the end box 54 corresponding to the first power supply 74. The first power supply 74 is positioned beneath the first battery cover 76.

A second light emitter 78 is coupled to the housing 60. The second light emitter 78 is positioned on the bottom side 56 corresponding to the central box 52. Thus, the second light emitter 78 emits light onto the support surface 14. The second light emitter 78 may comprise an LED strip or the like.

A second charge port 80 is coupled to the housing 60 and the second charge port 80 is positioned on an associated one of the end boxes 54. The second charge port 80 may be electrically coupled to an extrinsic electronic device 70. The extrinsic electronic device 70 may comprise a smart phone or the like. Thus, the second charge port 80 facilitates the extrinsic electronic device 70 to be remotely charged.

A second switch 82 is coupled to the housing 60 and the second switch 82 may be manipulated. The second switch 82 is electrically coupled to the second light emitter 78. The second switch 82 is positioned on the top side 58 corresponding to the central box 52.

A second power supply 84 is positioned within an associated one of the end boxes 54. The second power supply 84 is electrically coupled to the second switch 82 and the second charge port 80. The second power supply 84 comprises at least one battery. A second battery cover 86 is removably coupled to the top side 58 of the end box 54 corresponding to the second power supply 84. The second power supply 84 is positioned beneath the second battery cover 86.

In use, the middle member 34 is coupled between each of the uprights 20. Each of the uprights 20 is positioned on the support surface 14. Moreover, the stand is positioned adjacent to a body of water. The lighting unit 48 is positioned between each of the uprights 20. The line 18 on the at least one fishing pole 16 is cast into the body of water. The at least one fishing pole 16 is leaned against the middle member 34. The at least one fishing pole 16 is positioned in a selected one of the valleys 42.

The first switch 72 is manipulated to turn on the plurality of first light emitters 66. Thus, the line 18 on the at least one fishing pole 16 fluoresces thereby facilitating the line 18 to be visible at night. The second switch 82 is manipulated to turn on the second light emitter 78. Thus, the second light emitter 78 illuminates the support surface 14 thereby facilitating a tackle box or the like to be accessed at night. The extrinsic electronic device 70 may be electrically coupled to the first charge port 68 and the second charge port 80 at any time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A nighttime fishing assembly comprising:
a stand being configured to be positioned on a support surface thereby facilitating said stand to support at least one fishing pole, said stand being configured to be positioned adjacent to a body of water thereby facilitating a line of the fishing pole to be cast into the body of water; and
a lighting unit being removably coupled to said stand when said stand is positioned in the support surface, said lighting unit being configured to emit ultraviolet light thereby facilitating the line from the at least one fishing pole to fluoresce at night.

2. The assembly according to claim 1, wherein:
said stand includes a pair of uprights, each of said uprights being configured to extend upwardly from the support surface having said uprights being spaced apart from each other; and
each of said uprights comprises:
a pair of outward arms, each of said outward arms having a first end and a second end, said first end corresponding to each of said outward arms being coupled together such that said second end corresponding to each of said outward arms are spaced apart from each other, said second end corresponding to each of said outward arms being configured to abut the support surface, and
a central arm being coupled to and extending between said pair of outward arms, said central arm being centrally positioned between said first end and said second end.

3. The assembly according to claim 2, further comprising a sleeve being coupled to said outward arms, said sleeve being positioned on an intersection of said first end corresponding to said outward arms, said sleeve being oriented such that a line extending longitudinally through said sleeve bisects a triangle formed by said outward arms.

4. The assembly according to claim 2, further comprising a pair of hooks, each of said hooks being coupled to and extending away from one of said outward arms, each of said hooks being configured to have a rope attached thereto thereby facilitating said outward arms to be restrained on the support surface.

5. The assembly according to claim 2, further comprising a middle member being suspended between said pair of uprights when said uprights are positioned on the support surface wherein said middle member is configured to have the at least one fishing pole leaned thereon, said middle member having a primary end and a secondary end, said middle member having a plurality of bends thereon, said bends being spaced apart from each other and being distributed along said middle member to define a plurality of valleys on said middle member, a selected one of said valleys being configured to have the at least one fishing pole positioned therein thereby inhibiting the fishing pole from sliding laterally along said middle member.

6. The assembly according to claim 5, wherein:
each of said uprights includes a sleeve; and
said middle member including a pair of rods, each of said rods being coupled to an associated one of said primary end and said secondary end, each of said rods being oriented transverse to said middle member, said sleeve corresponding to each of said uprights slidably receiving an associated one of said rods such that said middle member extends between said pair of uprights wherein said valleys are configured to point toward the support surface.

7. The assembly according to claim 2, wherein said lighting unit comprises a housing comprising a central box extending between a pair of end boxes, said end boxes being spaced apart from each other, each of said end boxes extending downwardly from said central box, said housing having a bottom side, a top side and a front side, said central box extending beyond each of said end boxes to define a pair of ledges on said housing, each of said ledges resting on said central arm of an associated one of said uprights such that said housing is supported above the support surface.

8. The assembly according to claim 7, further comprising a plurality of first light emitters, each of said first light emitters being coupled to said housing, each of said first light emitters being positioned on said front side corresponding to said central box wherein each of said first light emitters is configured to emit outwardly from said housing thereby facilitating said first light emitters to illuminate the line on the at least one fishing pole.

9. The assembly according to claim 8, further comprising a first charge port being coupled to said housing, said first charge being positioned an associated one of said end boxes, said first charge port being configured to be electrically coupled to an extrinsic electronic device.

10. The assembly according to claim 8, further comprising a first switch being coupled to said housing wherein said first switch is configured to be manipulated, said first switch being electrically coupled to each of said first light emitters, said first switch being positioned on said top side corresponding to said central box.

11. The assembly according to claim 7, further comprising a second light emitter being coupled to said housing, said second light emitter being positioned on said bottom side corresponding to said central box wherein said second light emitter is configured to emit light onto the support surface.

12. The assembly according to claim 11, further comprising a second charge port being coupled to said housing, said second charge port being positioned on an associated one of said end boxes, said second charge port being configured to be electrically coupled to an extrinsic electronic device.

13. The assembly according to claim 11, further comprising a second switch being coupled to said housing wherein said second switch is configured to be manipulated, said second switch being electrically coupled to said second light emitter, said second switch being positioned on said top side corresponding to said central box.

14. The assembly according to claim 10, further comprising:
a first charge port; and
a first power supply being positioned in an associated one of said end boxes, said first power supply being electrically coupled to said first switch and said first charge port, said first power supply comprising at least one battery.

15. The assembly according to claim 13, further comprising:
a second charge port; and
a second power supply being positioned within an associated one of said end boxes, said second power supply being electrically coupled to said second switch and said second charge port, said second power supply comprising at least one battery.

16. A nighttime fishing assembly comprising:
a stand being configured to be positioned on a support surface thereby facilitating said stand to support at least one fishing pole, said stand being configured to be positioned adjacent to a body of water thereby facilitating a line of the at least one fishing pole to be cast into the body of water, said stand comprising:
a pair of uprights, each of said uprights being configured to extend upwardly from the support surface having said uprights being spaced apart from each other, each of said uprights comprising:
a pair of outward arms, each of said outward arms having a first end and a second end, said first end corresponding to each of said outward arms being coupled together such that said second end corresponding to each of said outward arms are spaced apart from each other, said second end corresponding to each of said outward arms being configured to abut the support surface,
a central arm being coupled to and extending between said pair of outward arms, said central arm being centrally positioned between said first end and said second end,
a sleeve being coupled to said outward arms, said sleeve being positioned on an intersection of said first end corresponding to said outward arms, said sleeve being oriented such that a line extending longitudinally through said sleeve bisects a triangle formed by said outward arms, and
a pair of hooks, each of said hooks being coupled to and extending away from one of said outward arms, each of said hooks being configured to have a rope attached thereto thereby facilitating said outward arms to be restrained on the support surface; and
a middle member being suspended between said pair of uprights when said uprights are positioned on the support surface wherein said middle member is configured to have the at least one fishing pole leaned thereon, said middle member having a primary end and a secondary end, said middle member having a plurality of bends thereon, said bends being spaced apart from each other and being distributed along said middle member to define a plurality of valleys on said middle member, a selected one of said valleys being configured to have the at least one fishing pole positioned therein thereby inhibiting the fishing pole from sliding laterally along said middle member, said middle member including a pair of rods, each of said rods being coupled to an associated one of said primary end and said secondary end, each of said rods being oriented transverse to said middle member, said sleeve corresponding to each of said uprights slidably receiving an associated one of said rods such that said middle member extends between said pair of uprights wherein said valleys are configured to point toward the support surface; and
a lighting unit being removably coupled to said stand when said stand is positioned in the support surface, said lighting unit being configured to emit ultraviolet light thereby facilitating the line from the fishing pole to fluoresce at night, said lighting unit comprising:
a housing comprising a central box extending between a pair of end boxes, said end boxes being spaced apart from each other, each of said end boxes extending downwardly from said central box, said housing having a bottom side, a top side and a front side, said central box extending beyond each of said end boxes to define a pair of ledges on said housing, each of said ledges resting on said central arm of an associated one of said uprights such that said housing is supported above the support surface,
a plurality of first light emitters, each of said first light emitters being coupled to said housing, each of said first light emitters being positioned on said front side corresponding to said central box wherein each of said first light emitters is configured to emit outwardly from said housing thereby facilitating said first light emitters to illuminate the line on the at least one fishing pole,
a first charge port being coupled to said housing, said first charge being positioned an associated one of said end boxes, said first charge port being configured to be electrically coupled to an extrinsic electronic device,
a first switch being coupled to said housing wherein said first switch is configured to be manipulated, said first switch being electrically coupled to each of said first light emitters, said first switch being positioned on said top side corresponding to said central box,
a second light emitter being coupled to said housing, said second light emitter being positioned on said bottom side corresponding to said central box wherein said second light emitter is configured to emit light onto the support surface,
a second charge port being coupled to said housing, said second charge port being positioned on an associated one of said end boxes, said second charge port being configured to be electrically coupled to an extrinsic electronic device,
a second switch being coupled to said housing wherein said second switch is configured to be manipulated, said second switch being electrically coupled to said second light emitter, said second switch being positioned on said top side corresponding to said central box,
a first power supply being positioned in an associated one of said end boxes, said first power supply being electrically coupled to said first switch and said first charge port, said first power supply comprising at least one battery, and
a second power supply being positioned within an associated one of said end boxes, said second power supply being electrically coupled to said second switch and said second charge port, said second power supply comprising at least one battery.
